(19) United States
(12) Patent Application Publication
(10) Pub. No.: US 2024/0014485 A1
(43) Pub. Date: Jan. 11, 2024

(54) SINGLE-ENDED CYLINDRICAL BATTERY CELL CONNECTOR

(71) Applicant: Derek Simkowiak, Lynnwood, WA (US)

(72) Inventor: Derek Simkowiak, Lynnwood, WA (US)

(73) Assignee: Holding Zero, LLC, Albuquerque, NM (US)

(21) Appl. No.: 18/349,724

(22) Filed: Jul. 10, 2023

Related U.S. Application Data
(60) Provisional application No. 63/359,246, filed on Jul. 8, 2022.

(51) Int. Cl. H01M 50/179; H01M 50/107; H01M 50/559; H01M 10/42

(52) U.S. Cl. CPC H01M 50/179; H01M 50/107; H01M 50/559; H01M 10/425

(57) ABSTRACT

The present disclosure describes a battery connector for cylindrical battery cells having a positively charged anode contiguous with the circular, or oval, first end, a negatively charged cathode contiguous with the circular, or oval, second end, and straight parallel sides electrically connected with said cathode. The battery connector has an electrically nonconductive outer shell, open-ended on one side, with a cylindrical inner cavity into which one end of the battery cell is inserted. In the preferred embodiment, the nonconductive outer shell is comprised of plastic. In another embodiment, the nonconductive outer shell may be comprised of a Silicon-based material, but other embodiments are also possible. In the preferred embodiment, the nonconductive outer shell is sufficiently tall, and the cylindrical cavity's diameter is sufficiently narrow, to substantially prevent either the anode or the cathode of the battery cell from contacting both battery terminals simultaneously.

### CROSS-REFERENCE TO RELATED APPLICATIONS

This application claims the benefit of U.S. Provisional Patent Application Ser. No. 63/359,246 filed Jul. 8, 2022, titled “SINGLE-ENDED CYLINDRICAL BATTERY CELL CONNECTOR,” and the subject matter thereof is incorporated herein by reference thereto.

### TECHNICAL FIELD

The present disclosure relates to a battery connector. More particularly, the present disclosure relates to structural and electrical aspects of a single-ended cylindrical battery connector.

### BACKGROUND ART

The present disclosure describes a battery cell connector for substantially tall cylindrical battery cells having cylinder base diameters smaller than their cylinder heights, including, but not limited to, the cylindrical battery cell models 18650, 21700, and 26650 that have been standardized by the International Electrotechnical Commission (IEC) and the American National Standards Institute (ANSI), in applications where a single end of the battery is inserted into the connector.

Running an electrical conductor, such as wire, for the height of the cell cylinder increases material cost, restricts the angle of insertion and removal, and increases the likelihood of a dangerous electrical short between the anode and cathode of the battery cell. Thus, an improved cylindrical battery cell connector is required which reduces or removes one or more of the issues mentioned.

None of the prior art fully addresses the problems resolved by the present invention. The present invention overcomes these limitations contained in the prior art.

Certain embodiments of the invention have other steps or elements in addition to or in place of those mentioned above. The steps or element will become apparent to those skilled in the art from a reading of the following detailed description when taken with reference to the accompanying figures, if any.

### BRIEF DESCRIPTION OF THE SEVERAL VIEWS OF THE DRAWINGS

FIG. 1 illustrates a perspective view of the single-ended cylindrical battery cell connector, according to certain embodiments of the invention.

FIG. 2 illustrates a side view of the single-ended cylindrical battery cell connector, according to certain embodiments of the invention.

FIG. 3 illustrates a top view of the single-ended cylindrical battery cell connector, according to certain embodiments of the invention.

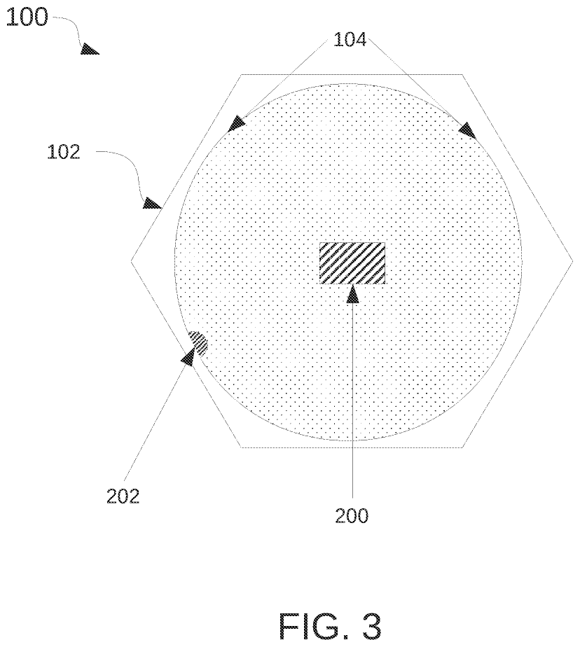

FIG. 4 illustrates a method of assembling the single-ended cylindrical battery cell connector, according to certain embodiments of the invention.

FIG. 5 illustrates a method of assembling the single-ended cylindrical battery cell connector, according to certain embodiments of the invention.

### DETAILED DESCRIPTION OF THE INVENTION

The best mode for carrying out the invention will be described herein. The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. To avoid obscuring the present invention, some well-known system configurations, and process steps are not disclosed in detail. The figures illustrating embodiments of the system, if any, are semi-diagrammatic and not to scale and, particularly, some of the dimensions are for the clarity of presentation and are shown exaggerated in the drawing figures.

Alternate embodiments have been included throughout, and the order of such are not intended to have any other significance or provide limitations for the present invention.

For expository purposes, the term “horizontal” as used herein is defined as a plane parallel to the plane or surface of the present apparatus, regardless of its orientation. The term “vertical” refers to a direction perpendicular to the horizontal as just defined. Terms, such as “above”, “below”, “bottom”, “top”, “side”, “higher”, “lower”, “upper”, “over”, and “under”, are defined with respect to the horizontal plane, as shown in the figures, if any. The term “on” means that there is direct contact among elements.

The words “including”, “comprising”, “incorporating”, “consisting of”, “have”, and “is” are meant to be non-exclusive, meaning additional items, components or elements may be present. Joinder references such as “connected”, “connecting”, and “coupled” do not limit the position, orientation, or use of systems and/or methods, and do not necessarily infer that two elements are directly connected. All identifying numerical terms are for identification only, and do not refer to the order or preference of any element, embodiment, variation and/or modification.

The present disclosure provides a single-ended cylindrical battery cell connector comprising a nonconductive outer shell; a cylindrical inner cavity; a positive terminal located near the circular base of the cylindrical inner cavity positioned parallel to the length of the cylindrical inner cavity; a negative terminal located near the inner wall of the cylindrical inner cavity positioned perpendicular to the length of the cylindrical inner cavity, such that when in use, the negative terminal connects to the curved, electrically conductive cathode surface of the cylindrical inner cavity; a positive connector lead; and a negative connector lead; wherein the cylindrical inner cavity is open-ended on one side such that a cylindrical battery cell having a cylinder base diameter less than its cylinder height can be inserted into the cylindrical inner cavity.

The present disclosure further provides a method of assembling a single-ended cylindrical battery cell connector, the method comprising forming a nonconductive outer shell; forming a positive connector lead and positive terminal from a first electrically conductive material; forming a negative connector lead and negative terminal from a second electrically conductive material coupling the first electrically conductive material into the nonconductive outer shell; and coupling the second electrically conductive material into the nonconductive outer shell.

The present disclosure further provides a method of assembling a single-ended cylindrical battery cell connector, the method comprising forming a positive connector lead and positive terminal from a first electrically conductive material; forming a negative connector lead and negative terminal from a second electrically conductive material; coupling the first electrically conductive material into a positioned nonconductive outer shell; and coupling the second electrically conductive material into a positioned nonconductive outer shell.

The present disclosure provides a battery connector for cylindrical battery cells having a positively charged anode contiguous with the circular, or oval, first end, a negatively charged cathode contiguous with the circular, or oval, second end, and straight parallel sides electrically connected with said cathode. The battery connector has an electrically nonconductive outer shell, open-ended on one side, with a cylindrical inner cavity into which one end of the battery cell is inserted. In the preferred embodiment, the nonconductive outer shell is comprised of plastic. In another embodiment, the nonconductive outer shell may be comprised of a Silicon-based material, but other embodiments are also possible.

Details to specific aspects or features of the present inventions are described below. Certain examples are illustrated in the accompanying drawings. Corresponding reference numbers will be used throughout the drawings to refer to the same or corresponding parts.

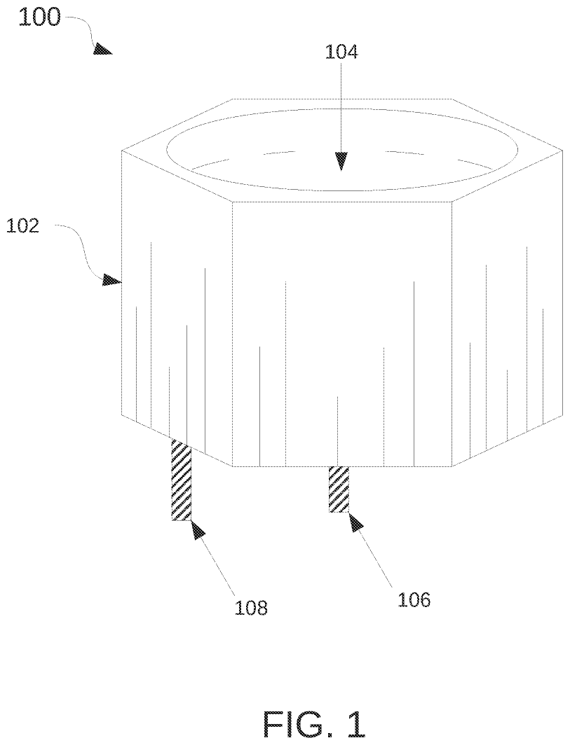

FIG. 1 illustrates a perspective view of the single-ended cylindrical battery cell connector 100, according to certain embodiments of the invention. In the preferred embodiment, the nonconductive outer shell 102 is sufficiently tall, and the cylindrical cavity's diameter is sufficiently narrow, to substantially prevent either the anode or the cathode of the battery cell from contacting both battery terminals simultaneously. The diameter of the cylindrical inner cavity 104 is less than about 9% wider than the diameter of the cylindrical battery cells for which it is designed. In some embodiments, the nonconductive outer shell 102 may have holes or other areas of missing material, for example, to reduce material cost, or to allow a gas flow pathway in the operational design.

The battery connector has a positive connector lead 106 and negative connector lead 108 electrically connected to the positive terminal and negative terminal 202, respectively. In the preferred embodiment, the connector leads are suitable for through-hole reflow (THR) mounting on a printed circuit board (PCB), as would be known to those of skill in the art. In another embodiment, the connector leads are suitable for surface-mount technology (SMT) mounting, as would be known to those of skill in the art. In other embodiments, the connector leads may be wires. Other embodiments are also possible.

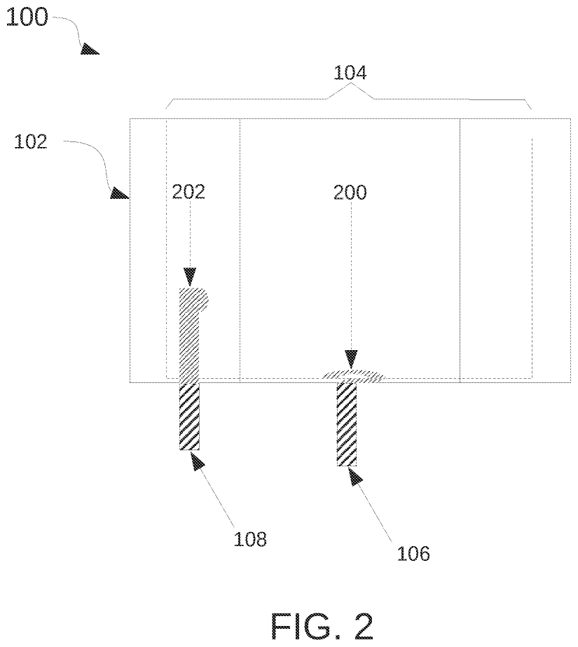

FIG. 2 illustrates a side view of the single-ended cylindrical battery cell connector 100, according to certain embodiments of the invention. The battery connector has a positive terminal for the anode of the battery cell, located on the circular inside base of the cylindrical inner cavity 104, with its contact surface facing about perpendicular to the length of the battery cell. When in use, the positive terminal connects to the electrically conductive anode surface on the base of the battery cell's cylinder shape. In some embodiments, the positive terminal is comprised of a leaf spring. In some embodiments, the positive terminal is comprised of a spiral spring.

The battery connector has a negative terminal 202 for the cathode of the battery cell on the round inside of the cylindrical inner cavity 104, with its contact surface facing about perpendicular to the tangent of the rounded tube wall of the battery cell. When in use, the negative terminal 202 connects to the curved, electrically conductive cathode surface of the battery cell's cylinder wall.

In some embodiments, the battery cell can be physically secured into place by inserting it into the connector, such that it will not fall out of the connector during normal operating conditions. In other embodiments, the battery cell remains sufficiently loose during normal operation that it can be made to fall out if held at a substantially steep angle, for example, if it is held upside-down.

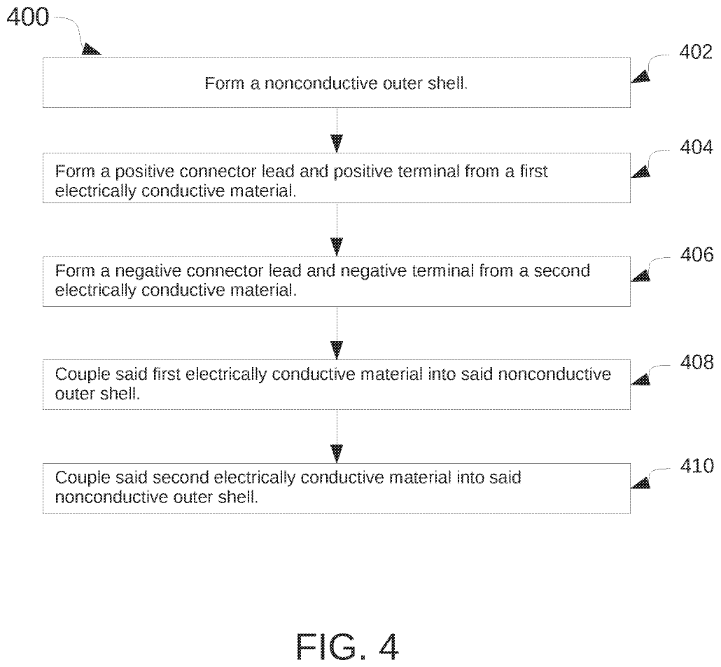

FIG. 4 illustrates a method of assembling the single-ended cylindrical battery cell connector 100, according to certain embodiments of the invention. According to method 400, at step 402 a nonconductive outer shell 102 is formed. For example, plastic or silicone may be molded, or ceramic may be cut, as would be known to those of skill in the art. According to method 400, at step 404 a positive connector lead 106 and positive terminal are formed from a first electrically conductive material. For example, a template of a coupled positive connector lead 106 and positive terminal could be stamped, etched, or pressed from sheet metal, as would be known to those of skill in the art. Additional treatment, such as nickel or gold plating for enhanced electrical connectivity, is also possible.

According to method 400, at step 406 a negative connector lead 108 and negative terminal 202 are formed from a first electrically conductive material. For example, a template of a coupled positive connector lead 106 and positive terminal could be stamped, etched, or pressed from sheet metal, as would be known to those of skill in the art. Additional treatment, such as nickel or gold plating for enhanced electrical connectivity, is also possible.

According to method 400, at step 408 said first electrically conductive material is coupled into said nonconductive outer shell 102, and at step 410, said second electrically conductive material is coupled into said nonconductive outer shell 102. In some embodiments, the spring coefficient of the formed electrically conductive materials could allow them to snap, or lock, into place permanently. In other embodiments, additional fastening may be used to couple the comprising parts.

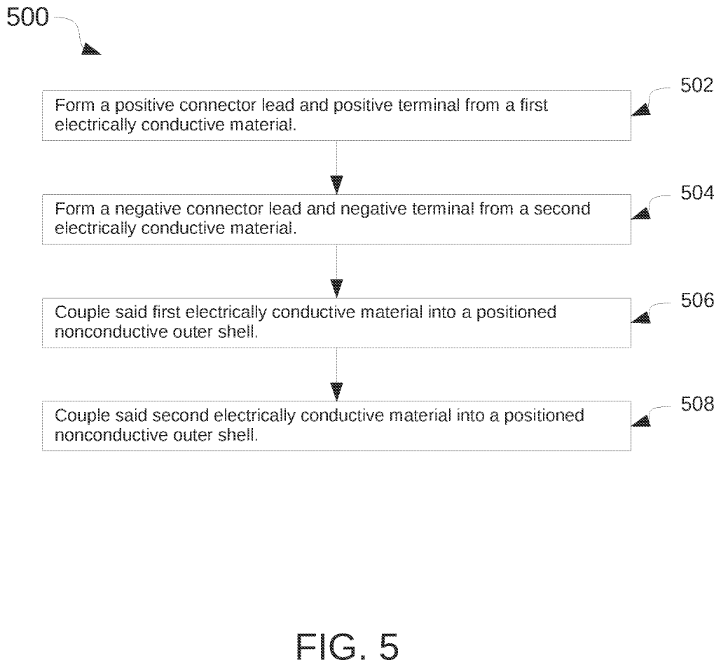

FIG. 5 illustrates a method of assembling the single-ended cylindrical battery cell connector 100, according to certain embodiments of the invention. Although similar art may be used for steps 404, 406 and 502, 504 respectively, in this method the nonconductive outer shell 102 has been positioned as part of a larger assembly or method of assembly. According to method 500, at step 506 said first electrically conductive material is coupled into a positioned nonconductive outer shell 102. According to method 500, at step 508 said second electrically conductive material is coupled into a positioned nonconductive outer shell 102. For example, substantially large arrays of battery cell connector 100s may have coupled nonconductive outer shell 102s which are part of a larger assembly, which are produced as a single collective part to reduce material waste and production cost.

The best mode for carrying out the invention has been described herein. The previous embodiments are described in sufficient detail to enable those skilled in the art to make and use the invention. It is to be understood that other embodiments would be evident based on the present disclosure, and that system, process, or mechanical changes may be made without departing from the scope of the present invention.

In the previous description, numerous specific details and examples are given to provide a thorough understanding of the invention. However, it will be apparent that the invention may be practiced without these specific details and specific examples. While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations that fall within the scope of the included claims. All matters previously set forth herein or shown in the accompanying figures are to be interpreted in an illustrative and non-limiting sense.

### LIST OF ELEMENTS SHOWN ON THE DRAWINGS

100 Single-ended cylindrical battery cell connector
102 Nonconductive outer shell
104 Cylindrical inner cavity
106 Positive connector lead
108 Negative connector lead
200 Positive terminal
202 Negative terminal
400 Method
402 Step
404 Step
406 Step
408 Step
410 Step
500 Method
502 Step
504 Step
506 Step
508 Step

What is claimed is:

1. A single-ended cylindrical battery cell connector comprising:
a nonconductive outer shell;
a cylindrical inner cavity;
a positive terminal located near the circular base of the cylindrical inner cavity positioned parallel to the length of the cylindrical inner cavity;
a negative terminal located near the inner wall of the cylindrical inner cavity positioned perpendicular to the length of the cylindrical inner cavity, such that when in use, the negative terminal connects to the curved, electrically conductive cathode surface of the cylindrical inner cavity;
a positive connector lead; and
a negative connector lead;
wherein the cylindrical inner cavity is open-ended on one side such that a cylindrical battery cell having a cylinder base diameter less than its cylinder height can be inserted into the cylindrical inner cavity.

2. The single-ended cylindrical battery cell connector of claim 1, wherein the nonconductive outer shell has a diameter and length sufficient to substantially prevent an anode and a cathode of the single-ended cylindrical battery cell connector from making a simultaneous connection to either the positive terminal or the negative terminal, such that an electrical short is substantially prevented.

3. The single-ended cylindrical battery cell connector of claim 1, wherein the nonconductive outer shell is comprised of plastic.

4. The single-ended cylindrical battery cell connector of claim 1, wherein the nonconductive outer shell is comprised of a silicon-based material.

5. The single-ended cylindrical battery cell connector of claim 1, wherein the single-ended cylindrical battery cell connector is a surface-mountable device suitable for mounting on a printed circuit board.

6. The single-ended cylindrical battery cell connector of claim 1, wherein the single-ended cylindrical battery cell connector is suitable for through-hole reflow mounting on a printed circuit board.

7. The single-ended cylindrical battery cell connector of claim 1, wherein the positive terminal is comprised of a leaf spring.

8. The single-ended cylindrical battery cell connector of claim 1, wherein the positive terminal is comprised of a spiral spring.

9. The single-ended cylindrical battery cell connector of claim 1, wherein the cylindrical battery cell may be physically secured by inserting the cylindrical battery cell into the cylindrical battery cell connector, such that the cylindrical battery cell will not fall out of the connector during normal operating conditions.

10. The single-ended cylindrical battery cell connector of claim 1, wherein the cylindrical battery cell remains sufficiently loose during normal operation such that it can fall out if held at a substantially steep angle.

11. A method of assembling a single-ended cylindrical battery cell connector, the method comprising:
forming a nonconductive outer shell;
forming a positive connector lead and positive terminal from a first electrically conductive material;
forming a negative connector lead and negative terminal from a second electrically conductive material;
coupling the first electrically conductive material into the nonconductive outer shell; and
coupling the second electrically conductive material into the nonconductive outer shell.

12. A method of assembling a single-ended cylindrical battery cell connector, the method comprising:
forming a positive connector lead and positive terminal from a first electrically conductive material;
forming a negative connector lead and negative terminal from a second electrically conductive material;
coupling the first electrically conductive material into a positioned nonconductive outer shell; and
coupling the second electrically conductive material into a positioned nonconductive outer shell.
